(19) United States
(12) Patent Application Publication
(10) Pub. No.: US 2005/0178858 A1
(43) Pub. Date: Aug. 18, 2005

(54) Liquid spraying pistol with variable jet for gardening

(76) Inventor: Gianfranco Roman, Pasiano (PN) (IT)

Correspondence Address: JACOBSON HOLMAN;PROFESSIONAL LIMITED LIABILITY COMPANY, 400 SEVENTH STREET, N.W., WASHINGTON, DC, 20004, US

(21) Appl. No.: 11/052,213

(22) Filed: Feb. 8, 2005

(30) Foreign Application Priority Data
Feb. 13, 2004 (IT) MI 2004A 000239

(51) Int. Cl. A62C 5/02; B05B 1/32

(52) U.S. Cl. 239/526; 239/456; 239/457; 239/507; 239/499

(57) ABSTRACT

A liquid spraying pistol with variable jet is described, which is made up of a handle (1) comprising a start lever (2) and a channel (4) in which a valve (3) is slidingly housed which is operated by said start lever (2), and a jet dispensing pipe (5) comprising an internal channel (7) communicating with said channel (4) of the handle (1) and an external casing (6) bearing a diffuser (9) placed at the output of said internal channel (7). Said diffuser (9) is axially movable with respect to said internal channel (7) of the dispensing pipe (5) in order to modify the shape of the jet and at the inlet of said internal channel (5) a body is arranged which is turnable around its axis in order to vary the communication between said channel (4) of the handle and said internal channel (7) of the dispensing pipe. (FIG. 2).

The present invention concerns a liquid spraying pistol with variable jet for gardening.

There are known liquid spraying pistols comprising a handle containing an internal channel and provided with a start lever, and a pipe with a channel inside of it which allows the liquid to flow through an outflow diffuser placed on the head of the pistol.

Depending on the requirements it can be useful to have jets with different shape and rate. The shower shape of the jet is opportune if small plants must be watered, whereas the single jet and/or fan-jet is suitable for the watering of lawns and trees, even at a remarkable distance. The rate has an influence in turn on the length of the jet.

Object of the present invention to provide a pistol capable to vary both the shape of the jet and the rate of liquid.

According to the invention such object is attained with a liquid spraying pistol with variable jet, made up of a handle comprising a start lever and a channel in which a valve is slidingly housed which is operated by said start lever, and a jet dispensing pipe comprising an internal channel communicating with said channel of the handle and an external casing bearing a diffuser placed at the output of said internal channel, characterised in that said diffuser is movable axially with respect to said internal channel of the dispensing pipe in order to modify the shape of the jet and at the inlet of said internal channel a cylindrical body is arranged which is turnable around its axis in order to vary the communication between said channel of the handle and said internal channel of dispensing pipe and therefore to vary the outflow of liquid.

These and other characteristics of the present invention will be made evident from the following detailed description of an embodiment thereof which is illustrated as a non-limiting example in the enclosed drawing, in which:

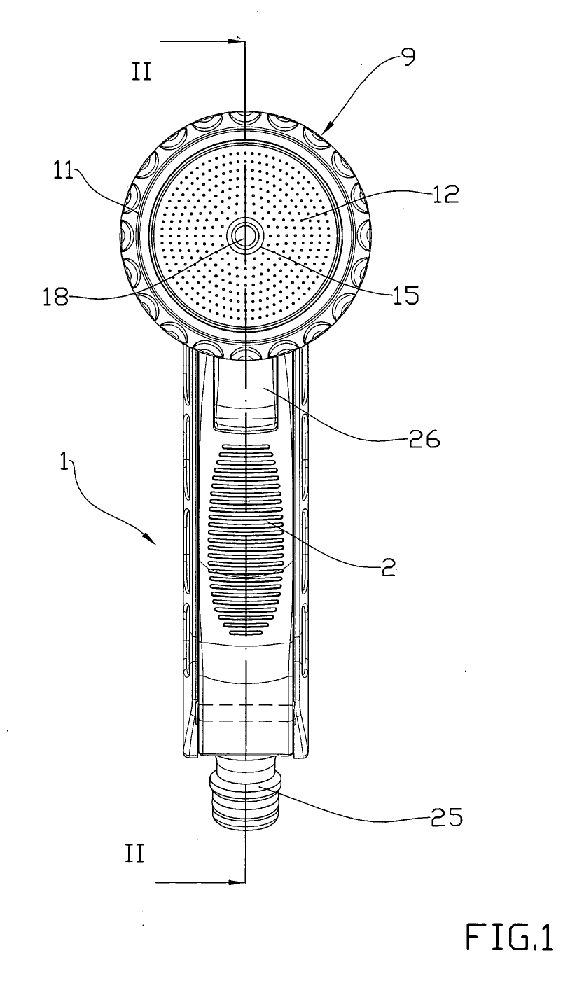

FIG. 1 shows a front view of a pistol according to the present invention;

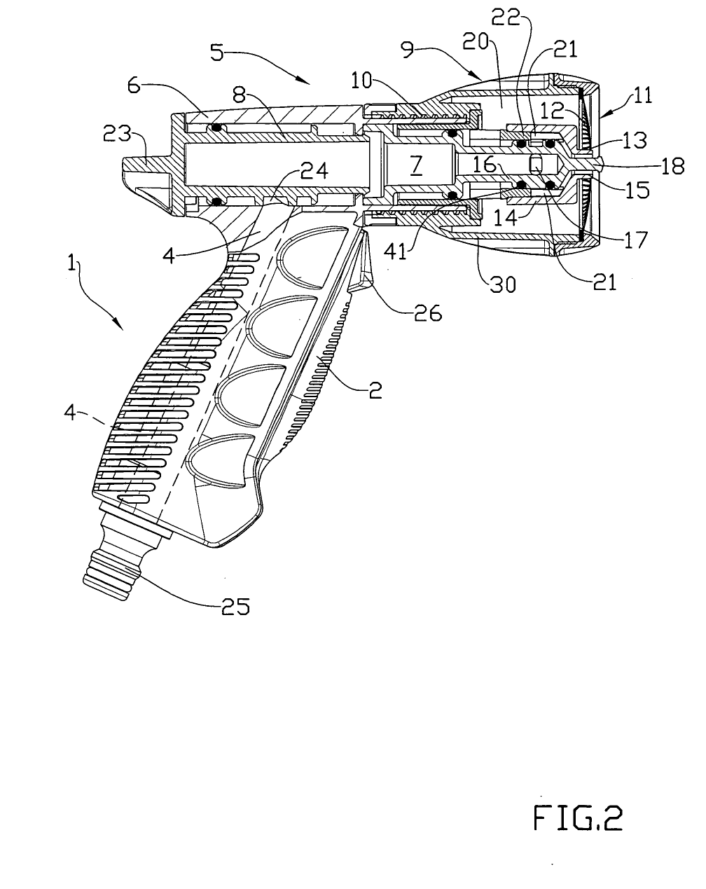

FIG. 2 shows a side view partially sectioned according to the line II-II of FIG. 1 with the diffuser in position such as to allow a thin central jet;

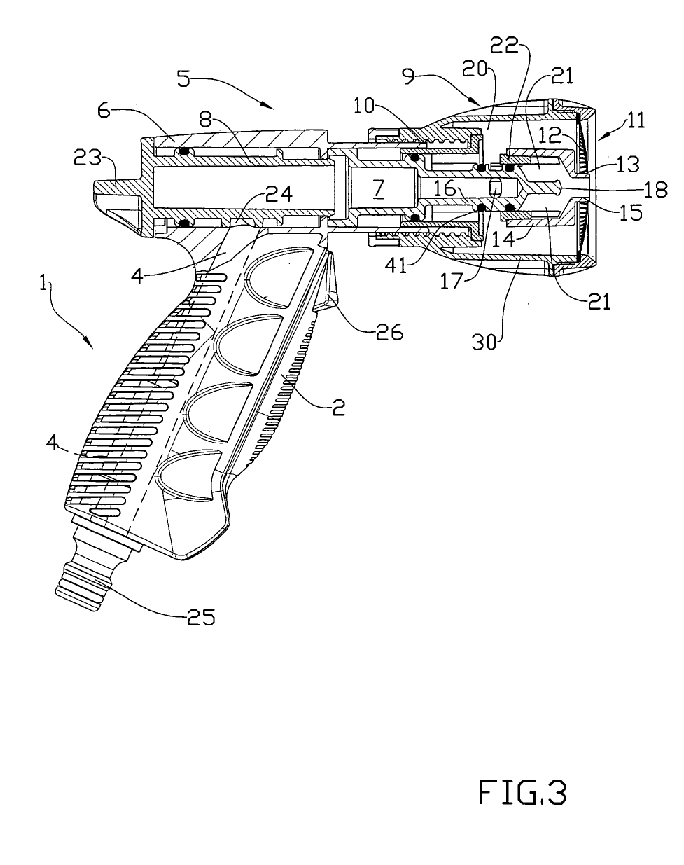

FIG. 3 shows a side view similar to FIG. 2 but with the diffuser in position such as to allow a jet with shower;

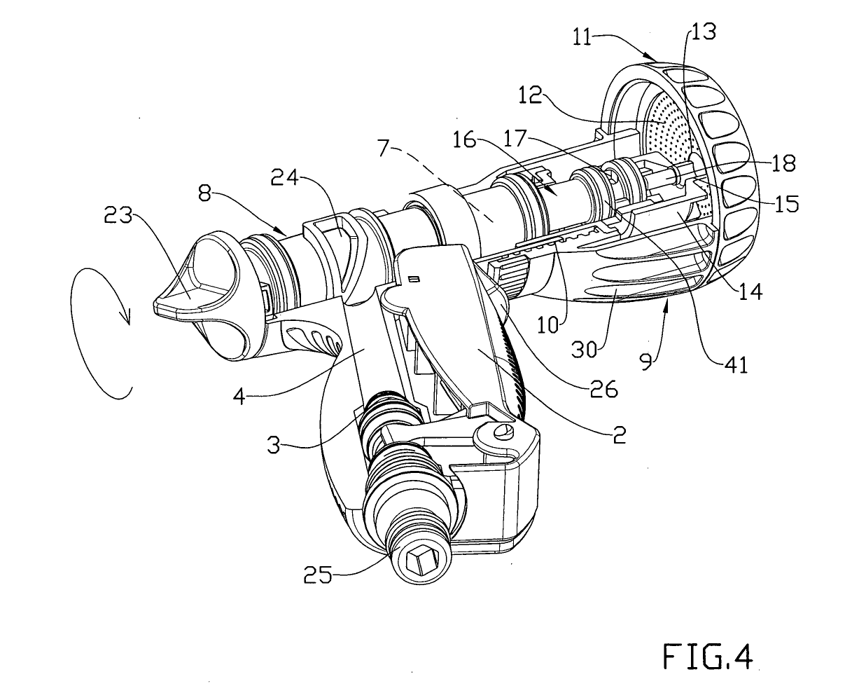

FIG. 4 shows a perspective view from the bottom of the pistol according to the present invention.

The drawings show a variable jet spraying pistol comprising a handle 1 which supports a start lever 2, which controls a valve 3 (FIG. 4) slidingly housed in an internal channel 4 (FIGS. 2 and 3) and is possibly held in fixed opening position by a button 26 (FIGS. 1-4), and a pipe 5, provided with an external casing 6 in which an internal channel 7 is obtained and which supports an adjustment cylindrical body 8 and a mobile diffuser 9.

The diffuser 9, which is movable in the direction of the axis of the channel 7 in virtue of a screw-thread coupling 10 with the external casing 6, comprises a front plate 11 provided with a plurality of small holes 12 and with a central hole 13, an external casing 30 and a cup shaped body 14 with a central hole 15.

The shape of the channel 7 in the fore part of the pipe 5 is defined by a cylindrical body with variable transversal section 16 which has transversal holes 17 and an axial projection 18 which defines the shape of the jet outflowing from the central hole 15.

In FIG. 2 one can notice how the water tightness between a round chamber 20 and an interstice 21 is assured by the coupling between the body 14 and a ring 22 with the aid of an annular packing 41.

The cylindrical body 8 is turnable around its axis by operating manually on a projection 23 and is provided with an opening 24 (FIG. 4) on the external surface, whose shape varies as a function of the angle of rotation of the same body 8.

A coupling 25 is capable to connect the channel 4 inside the handle 1 with the external water supply.

As for what concerns the operation, if assuming an initial situation with valve 3 closed, the liquid is supplied from the outside through the coupling 25 and gets to the inlet of the internal channel 4.

By means of the start lever 2 the valve 3 gets opened thus allowing the liquid to reach the pipe 5 through the opening 24. By rotating the projection 23 it is possible to set the quantity of liquid since the transversal section for the passage of the liquid through the opening 24 varies as a function of the angle of rotation of the cylindrical body 8 (FIG. 4).

By rotating the diffuser 9 it is possible to define the shape of the outflow jet. If said diffuser 9 is in the back position of FIG. 2, the liquid through the holes 17 and the interstice 21 will exit the pistol by passing through the output hole 15 partially occupied by the projection 18, which is used for a finer adjustment of the shape of the jet. In such position the chamber 20 remains dry in virtue of the water tightness guaranteed by the body 14—ring 22 coupling.

If one wants a “shower” shape of the outflow jet, the diffuser 9 must be rotated so as to move it forward into the axial direction owing to the screw-thread coupling 10. Said movement allows the generation of a space between the body 14 and the ring 22 for the passage of the liquid.

In FIG. 3 the pistol with the diffuser 9 in “shower” position is shown. The passage of the liquid available between the body 14 and the ring 22 can be observed. In such situation the liquid fills the chamber 20 in order then to exit through the holes 12 of the plate 11.

Also with the diffuser 9 in the “shower” position it is obviously possible to vary the rate by means of the rotation of the cylindrical body 8.

1. Liquid spraying pistol with variable jet, made up of a handle (1) comprising a start lever (2) and a channel (4) in which a valve (3) is slidingly housed which is operated by said start lever (2), and a jet dispensing pipe (5) comprising an internal channel (7) communicating with said channel (4) of the handle (1) and an external casing (6) bearing a diffuser (9) placed at the output of said internal channel (7), characterised in that said diffuser (9) is axially movable with respect to said internal channel (7) of the dispensing pipe (5) in order to modify the shape of the jet and at the inlet of said internal channel (5) a cylindrical body (8) is arranged which is turnable around its axis in order to vary the communication between said channel (4) of the handle and said internal channel (7) of the dispensing pipe and therefore to vary the quantity of the liquid.

2. Pistol according to claim 1, characterised in that said diffuser (9) is turnable with respect to the external casing (6).

3. Pistol according to claim 2, characterised in that said diffuser (9) is connected with the external casing (6) through a screw-thread coupling (10).

4. Pistol according to claim 1, characterised in that said diffuser (9) comprises an output front plate (11) with a central hole (13) and with a multitude of peripheral holes (12).

5. Pistol according to claim 1, characterised in that said cylindrical body (8) comprises an opening (24) for the communication with the channel (4) of the handle (1), having a shape variable as a function of the rotation of the same cylindrical body (8).
